(19) United States
(12) Patent Application Publication
(10) Pub. No.: US 2003/0128177 A1
(43) Pub. Date: Jul. 10, 2003

(54) Driving method of liquid crystal display device and liquid crystal display device

(76) Inventors: Naoto Inoue, Shiki-gun (JP); Tomohiko Yamamoto, Nara-shi (JP); Keiichi Tanaka, Tenri-shi (JP); Hideki Ichioka, Nabari-shi (JP); Koji Fujiwara, Tenri-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/315,035

(22) Filed: Dec. 10, 2002

(30) Foreign Application Priority Data
Jan. 9, 2002 (JP) 2002-002827

(51) Int. Cl. G09G 3/36

(52) U.S. Cl. 345/87

(57) ABSTRACT

A driving method of a liquid crystal display device is performed with respect to a liquid crystal display device arranged so that: a TFT having a gate electrode, a drain electrode, and a source electrode is provided on a first substrate; the gate electrode is connected to a scanning line, the drain electrode is connected to a pixel electrode and the source electrode is connected to a reference line; and signal lines are provided on a second substrate opposite to the first substrate; and the liquid crystal display device applies an electric field to a liquid crystal layer provided between the pixel electrode and the second substrate. The method comprising the step of: driving the signal lines that apply a voltage to a line of pixels scanned by the scanning line so that signal lines Sm−1 and Sm+1 at both ends of three adjacent signal lines Sm−1, Sm and Sm+1 are respectively supplied with a voltage opposite to each other in polarity. On this account, only one of the signal lines Sm−1 and Sm+1 will have a voltage opposite in polarity with respect to the voltage polarity of the signal line Sm, and therefore only one adjacent signal line affects on each signal line and the influence from the adjacent signal lines can be cut in half. As a result, it becomes possible to prevent the influence of voltage variation caused by the adjacent signal lines, thereby providing high display quality.

### FIELD OF THE INVENTION

The present invention relates to a driving method of a liquid crystal display device, and in particular to a driving method of liquid crystal display device with a short gap length between the signal lines, such as a counter signal line structure, and a liquid crystal display device using the driving method.

### BACKGROUND OF THE INVENTION

As shown in FIG. 2, in a liquid crystal display device having a counter signal line structure, a scanning line 11, a reference line 13, a TFT 14 and a pixel electrode 15 are disposed on a substrate (not shown), and a signal line 12 also operating as a counter pixel electrode is disposed on a counter substrate (not shown) while being filled with liquid crystal therebetween. Note that, FIG. 2 is an explanatory view showing a panel structure of a liquid crystal display device according to the present invention.

There are three types of method for driving a liquid crystal display device having the counter signal line structure: a 1H line reversal drive scheme, a dot reversal drive scheme, and a source line reversal drive scheme. The following will explain the details of these driving methods. Note that, the following explanation uses a liquid crystal display device adopting an active matrix drive scheme, especially the one using a TFT, with an arrangement such that a scanning line 11 is aligned in a row direction, and a signal line 12 is aligned in a column direction.

Firstly, in the 1H line reversal drive scheme, all of the signal lines S are reversed in polarity for each 1H period (1 horizontal scanning period) as shown in FIGS. 10(a) and 10(b). More specifically, when a scanning line Gn is scanned, the polarities of all signal lines S are plus, and when the next scanning line Gn+1 is scanned, the polarities of all signal lines S are minus. Further, in an odd number frame and in an even number frame, the polarity of the signal line S is generally reversed for respective frames in one specific pixel.

In this drive scheme, the polarities of the signal lines 12 are unified at a given time, and therefore a signal voltage can be lowered by carrying out alternating current driving with a reference voltage of direct current. For this reason, this drive scheme has a merit of allowing the display device to use a signal line driver in low voltage.

Secondly, in the dot reversal drive scheme, the signal lines S are alternately reversed in polarity as shown in FIGS. 11(a) and 11(b). More specifically, when a scanning line Gn is scanned, the polarity of a signal line Sm is plus, and the polarity of a signal line Sm+1 horizontally adjacent to the signal Sm is minus. Also, when the next scanning line Gn+1 is scanned, the polarity of the signal line Sm is minus, and the polarity of the signal line Sm+1 is plus. As a result, when scanning of 1 frame is completed, a plus polarity voltage and a minus polarity voltage are written on the pixels alternately in vertical and horizontal direction. Further, in an odd number frame and in an even number frame, the polarity of the signal line S is generally reversed for respective frames in one specific pixel.

In this drive scheme, a voltage in opposite polarity is written on vertically and horizontally adjacent pixels with respect to any given pixel, and therefore the display causes less flicker.

Thirdly, in the source line reversal drive scheme, writing is carried out with alternate polarities as shown in FIGS. 12(a) and 12(b). More specifically, when all scanning lines G in a frame are scanned, the polarity of a signal line Sm is plus, and the polarity of a signal line Sm+1 horizontally adjacent to the signal Sm is minus. Further, in an odd number frame and in an even number frame, the polarity of the signal line S is generally reversed also for respective frames in one specific pixel.

In this drive scheme, the polarity of a signal line 12 is reversed for each frame instead of for each 1H. For this reason, the display consumes less power.

Note that, the 1H line reversal drive scheme and the dot reversal drive scheme are disclosed in detail in Japanese Unexamined Patent Publication “Liquid crystal display device drive method” (Tokukai 2000-180826 Published on Jun. 30, 2000/corresponding U.S. patent application Ser. No. 09/411,704, Continuation application Ser. No. 10/167,626 of said U.S. patent application) applied by the same applicant as the present invention. Further, no other drive schemes have been disclosed other than those three drive schemes as a drive scheme used for a liquid crystal display device having the counter signal line structure.

However, when the conventional dot reversal drive scheme or the source line reversal drive scheme is adopted for driving a liquid crystal display device having the counter signal line structure, there arises a problem of a decrease of display quality.

Here, as shown in FIG. 4, since a signal line 12 also operates as a counter pixel electrode in the counter signal line structure, it is necessary to set the width of the signal line 12 large enough for increasing an aperture ratio so as to realize a liquid crystal display device with desirable brightness and visibility. To meet this requirement, a gap length d between the signal lines 12 becomes extremely small. In a liquid crystal display device with a general resolution, the gap length d between signals is set to be 2 to 12 μm. Note that, FIG. 4 is an explanatory view showing a panel structure of a liquid crystal display device according to the present invention.

Further, in the counter signal line structure, since the gap length d between signals is extremely small, capacity between the signal lines 12 becomes extremely large. The signal voltages of the adjacent signal lines 12 affect on each other due to the large capacity therebetween, then, when an applied voltage of liquid crystal is held after the application, variation of the applied voltage between the adjacent signal lines 12 varies the held voltage of liquid crystal driven by the signal line 12. As a result, translucence quantity of liquid crystal changes, and display quality decreases.

For example, when an examination pattern shown in FIG. 13 is displayed in a liquid crystal display device having the counter signal line structure panel driven by a dot reversal drive scheme or a source line reversal drive scheme, a vertical shadow shown in FIG. 14 appears. The following explains the mechanism of generation of the vertical shadow.

As shown in FIG. 15, when a liquid crystal display device having the counter signal line structure is driven by a dot reversal drive scheme or a source line reversal drive scheme, the signal voltage of the signal line Sm is opposite in polarity to those of the adjacent signal line Sm−1 and Sm+1. Thus, the signal line Sm is under the influence of the signal voltages of the signal line Sm−1 and the signal line Sm+1.

More specifically, when a scanning line G scans the part of central black square shown in FIG. 14, if the polarity of a voltage applied by the signal line Sm is plus, the polarities of the signal lines Sm−1 and the Sm+1 are both minus. Therefore, the signal voltages in the part of the black square affect on each other via the capacity between the signal lines. This causes an increase of the voltage with respect to the part holding white color above or below the black square. As a result, the vertical shadow appears above or below the black square.

### SUMMARY OF THE INVENTION

An object of the present invention is to provide a driving method of a liquid crystal display device and a liquid crystal display device that ensure high display quality.

In order to solve the foregoing problems, in a driving method of a liquid crystal display device according to the present invention, the liquid crystal display device is arranged so that: an active three terminals element having a gate electrode, a drain electrode, and a source electrode is provided on a first substrate; and the gate electrode is connected to a scanning line, the drain electrode is connected to a pixel electrode and the source electrode is connected to a reference line; and signal lines are provided on a second substrate opposite to the first substrate; and the liquid crystal display device applies an electric field to a liquid crystal layer provided between the pixel electrode and the second substrate, and the driving method includes the step of: driving the signal lines that apply a voltage to a line of pixels scanned by the scanning line so that signal lines at both ends of any three adjacent signal lines are respectively supplied with a voltage opposite to each other in polarity.

With the foregoing arrangement, signal lines, that apply a voltage to a line of pixels scanned by a scanning line Gn, are driven so that the signal lines Sm−1 and Sm+1 at the both ends of three adjacent signal lines Sm−1, Sm and Sm+1 are respectively supplied with a voltage opposite to each other in polarity. For example, when a voltage in plus polarity is applied to the signal line Sm, a voltage in minus polarity is applied to the signal line Sm−1 disposed to the left of the signal line Sm, and a voltage in plus polarity is applied to the signal line Sm+1 disposed to the right of the signal line Sm. As a result, a set of plus, plus, minus, minus in a signal line order is repeated for the polarity of the output voltage to the signal line 12 in this driving method.

On this account, looking at one specific signal line Sm of the plurality of signal lines, the source driver carries out driving so that the signal lines Sm−1 and Sm+1, which are adjacent to the signal line Sm, are opposite in polarity to each other.

Therefore, in the foregoing driving example, the signal line Sm is under the influence of the signal line Sm−1 disposed to the left of the signal line Sm since their voltages are opposite in polarity; however, the signal line Sm is not under the influence of the signal line Sm+1 provided to the right of the signal line Sm since their voltages are the same in polarity. Accordingly, the voltage variation of only one adjacent signal line affects on each signal line.

Thus, the influence of the voltage variation can be cut in half compared to the case of having the influence from both sides, i.e., a conventional driving method adopting the dot reversal drive scheme or the source line reversal drive scheme. Consequently, for example, when the examination pattern shown in FIG. 13 is displayed in the display device, the vertical shadow of FIG. 14 becomes small and invisible.

Accordingly, the foregoing driving method makes it possible to prevent the influence of voltage variation caused by the adjacent signal lines even in the counter signal line structure having a short gap length between the signal lines, thereby providing high display quality.

Further, in the driving method of a liquid crystal display device according to the present invention, the signal lines are supplied with a voltage that is reversed in polarity for each frame.

With the foregoing arrangement, the charge polarity is further reversed for each frame. In this manner, the voltage variation caused by the adjacent signal lines can be suppressed even in liquid crystal display device using the counter signal line structure having a short gap length between the signal lines and therefore realizes high display quality. Further, this driving method is performed in a manner similar to the conventional source line reversal drive scheme, and therefore a similar effect is expected. That is, since the polarity of the signal line is reversed for each frame instead of for each 1H, the display consumes less power.

Further, in the foregoing driving method, an alternating electric field may be applied to the liquid crystal, as the charge polarity is alternately reversed for each frame. Thus, it is possible to greatly reduce probability that impurity ion in the liquid crystal is moved and attached to one side of the device, thereby improving reliability of the liquid crystal display device.

Further, in the driving method of a liquid crystal display device according to the present invention, the signal lines are supplied with a voltage that is reversed in polarity for each scanning line.

With the foregoing arrangement, the charge polarity is further reversed for each scanning line. In this manner, the influence of the voltage variation from the adjacent signal lines can be suppressed even in liquid crystal display device using the counter signal line structure having a short gap length between the signal lines, and therefore realizes high display quality. Further, this driving method is performed in a manner similar to the conventional dot reversal drive scheme, and therefore a similar effect is expected. That is, since a voltage opposite in polarity is written on vertically and horizontally adjacent sets of two pixels with respect to any given set of two pixels, the display causes less flicker.

Further, in the liquid crystal display device according to the present invention, a driving circuit is provided for carrying out the foregoing driving method of a liquid crystal display device.

With the foregoing arrangement, it is possible to realize a liquid crystal display device of the counter signal line structure having a short gap length between the signal lines, which is capable of suppressing the influence of the voltage variation from the adjacent signal lines and realizing high display quality.

As described, in the present invention, the signal lines applying a voltage to a line of pixels scanned by the scanning line are driven so that signal lines at both ends of any three adjacent signal lines are respectively supplied with a voltage opposite to each other in polarity. With this arrangement, the vertical shadow caused by signal leakage occurred between adjacent source lines are prevented, thereby improving display quality.

Note that, in the teaching of the foregoing patent publication, an average value of reference line driving voltage is set to be higher than that of signal line driving voltage so as to prevent flicker by compensating apparent asymmetry of transmission rate with respect to both plus and minus driving voltages. The teaching of the foregoing publication is the same as the present invention in terms of line reversal driving in a counter source structure. However, the present invention carries out the line reversal with respect to signal lines unlike the foregoing publication which carries out the line reversal with respect to reference lines.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram schematically showing an arrangement of a source driver of a liquid crystal display device shown in FIG. 5.

FIG. 2 is an explanatory view schematically showing an electrode structure of a display panel of the liquid crystal display device shown in FIG. 5.

FIG. 3 is a circuit diagram schematically showing a wiring of the display panel of the liquid crystal display device shown in FIG. 5.

FIG. 4 is an explanatory view showing a gap length between signals of the display panel of the liquid crystal display device shown in FIG. 5.

FIG. 5 is a block diagram schematically showing an arrangement of a liquid crystal display device according to one embodiment of the present invention.

FIG. 6 is a timing chart showing a driving method of the liquid crystal display device shown in FIG. 5.

FIG. 7 is an explanatory view showing the driving polarities of signal lines in a driving method of the liquid crystal display device shown in FIG. 5.

FIG. 8(a) is an explanatory view of a concrete example of driving method of the liquid crystal display device shown in FIG. 5 showing a charge state of pixels when scanning of an odd number frame is completed.

FIG. 8(b) is an explanatory view of a concrete example of driving method of the liquid crystal display device shown in FIG. 5 showing a charge state of pixels when scanning of an even number frame is completed.

FIG. 9(a) is an explanatory view of another concrete example of driving method of the liquid crystal display device shown in FIG. 5 showing a charge state of pixels when scanning of an odd number frame is completed.

FIG. 9(b) is an explanatory view of another concrete example of driving method of the liquid crystal display device shown in FIG. 5 showing a charge state of pixels when scanning of an even number frame is completed.

FIG. 10(a) is an explanatory view of a 1H line reversal drive scheme according to a conventional technique showing a charge state of pixels when scanning of an odd number frame is completed.

FIG. 10(b) is an explanatory view of the 1H line reversal drive scheme according to a conventional technique showing a charge state of pixels when scanning of an even number frame is completed.

FIG. 11(a) is an explanatory view of a dot reversal drive scheme according to a conventional technique showing a charge state of pixels when scanning of an odd number frame is completed.

FIG. 11(b) is an explanatory view of the dot reversal drive scheme according to a conventional technique showing a charge state of pixels when scanning of an even number frame is completed.

FIG. 12(a) is an explanatory view of a source line reversal drive scheme according to a conventional technique showing a charge state of pixels when scanning of an odd number frame is completed.

FIG. 12(b) is an explanatory view of the source line reversal drive scheme according to a conventional technique showing a charge state of pixels when scanning of an even number frame is completed.

FIG. 13 is an explanatory view showing an examination pattern for a liquid crystal display device.

FIG. 14 is an explanatory view showing a vertical shadow, which appears when the examination pattern shown in FIG. 13 is displayed.

FIG. 15 is an explanatory view showing the driving polarities of signal lines in the dot reversal drive scheme shown in FIGS. 11(a) and 11(b), and in the source line reversal drive scheme shown in FIGS. 12(a) and 12(b).

FIG. 16 is a graph showing a relation between a length between signals and a parasitic capacity of a liquid crystal display device in a simulation.

FIG. 17 is an explanatory view showing a panel structure using an active matrix drive scheme according to a conventional technique.

FIG. 18 is an explanatory view showing a gap length between signals in the panel structure shown in FIG. 17.

### DESCRIPTION OF THE EMBODIMENTS

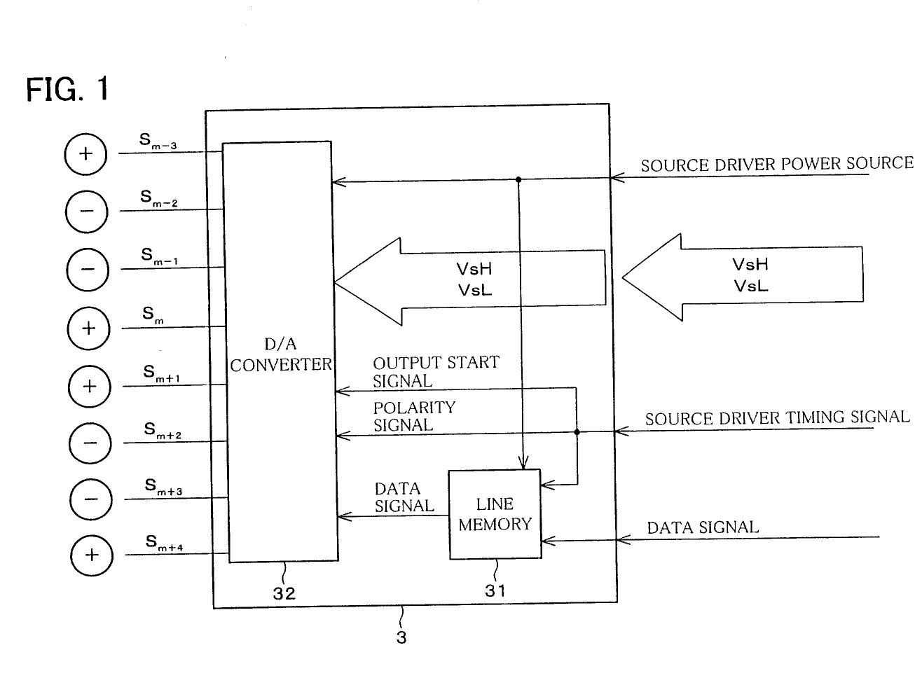

The following will explain one embodiment of the present invention with reference to FIGS. 1 through 9.

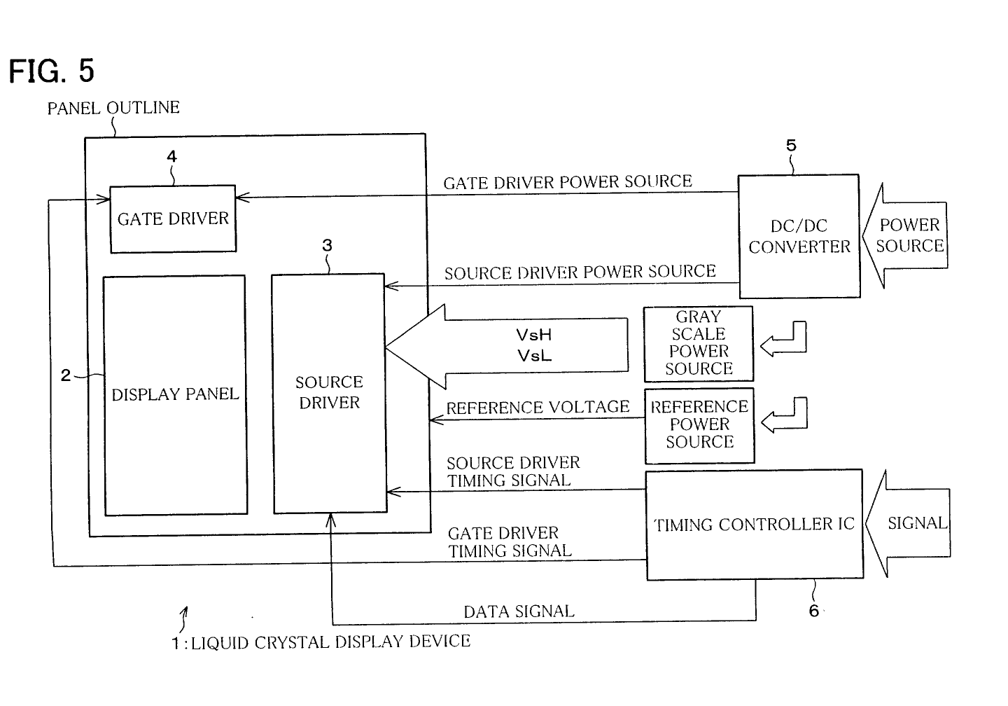

As shown in FIG. 5, a liquid crystal display device 1 according to the present embodiment includes a display panel 2, a source driver 3, a gate driver 4, a DC/DC converter 5, and a timing controller IC 6.

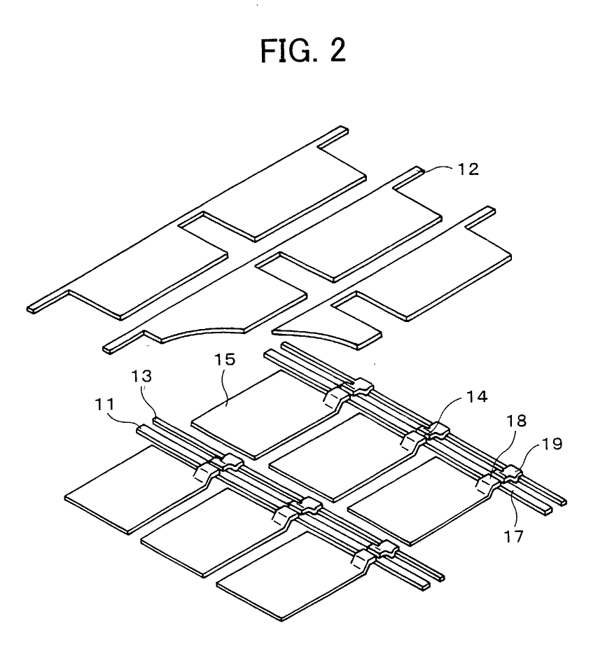

Firstly, the following will explain a structure of the panel 2 with reference to FIGS. 2 through 4.

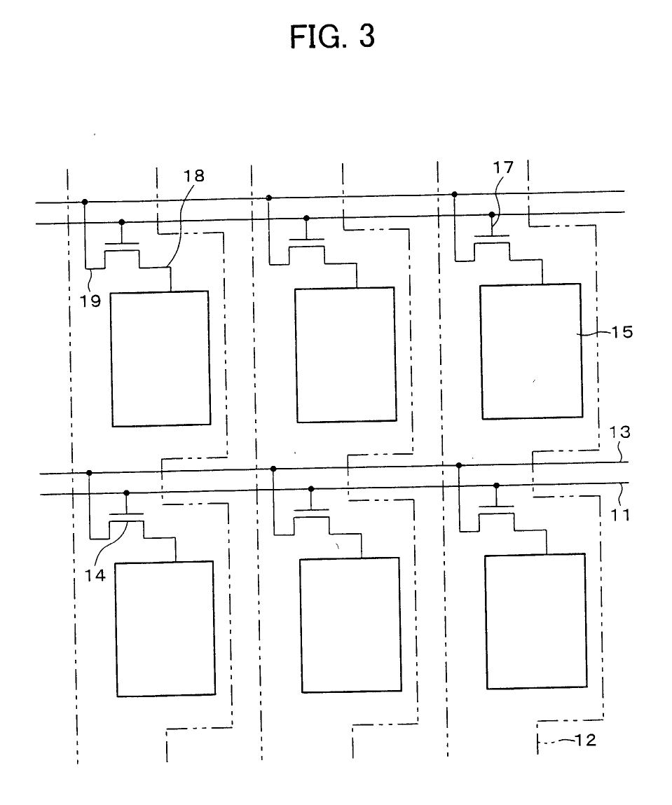

As shown in FIGS. 2 and 3, the liquid crystal display device 1 includes a display panel 2 in an active matrix drive scheme having a counter signal line structure. Note that, the liquid crystal display device 1 uses a TFT (Thin Film Transistor) as an active three terminals element; however, the present invention is not limited to this arrangement.

The display panel 2 has an insulative substrate (first substrate; not shown) thereon including a scanning line 11, and a reference line 13, which are made of a Tantalum (Ta) and the like, a pixel electrode 15 made of ITO (Indium-Tin Oxide) which are connected via a TFT 14. More specifically, a gate electrode 17 of the TFT 14 is connected to the scanning line 11, a drain electrode 18 is connected to a pixel electrode 15, and a source electrode 19 is connected to a reference line 13 on one substrate. Hereinafter, this substrate, having the TFT 14 formed thereon, is referred to as an active matrix substrate.

Further, the display panel 2 has another insulative substrate (second substrate; not shown), opposite to the active matrix substrate, thereon including a signal line 12 made of a transparent conductive film, as shown by a chain double-dashed line in FIG. 3. Generally, a transparent material such as ITO is used for this transparent conductive film making the signal line 12. Hereinafter, this substrate, having the signal line 12 formed thereon, is referred to as a counter substrate.

Further, in the display panel 2, a liquid crystal layer (not shown) is held between the signal lines 12 on the counter substrate and the pixel electrodes 15 on the active matrix substrate, and an electric field is applied to the liquid crystal layer.

Here, the following will briefly explain manufacturing processes of the display panel 2 of the liquid crystal display device 1.

Firstly, a conductive film is formed on a first insulative substrate made of a glass, a plastic or the like. Then, the film is patterned by a photolithography to be a predetermined film. Dry etching or wet etching can be used for the etching process. Further, a washing process may appropriately be added before and after each process. The scanning line 11 and the reference line 13 are formed through the first photolithography. Here, the gate electrode 17 of the TFT 14 is formed with the scanning line 11.

Next, an insulating film used as a function film of the TFT 14 connected to the pixel electrode 15 is formed. This insulating film is also used as the insulating film in each intersection of wirings.

The photolithography is repeated in the same manner so as to form a semiconductor layer of the TFT 14. Further, the drain electrode 18 and the source electrode 19 of the TFT 14 is formed. The source electrode 19 of the TFT 14 is connected to the reference line 13. Meanwhile, the drain electrode 18 of the TFT 14 is connected to the pixel electrode 15. The drain electrode 18 and the source electrode 19 of the TFT 14, and the pixel electrode 15 may be formed in one process according to circumstances.

In the mean time, a transparent conductive film to be the signal line 12 also operating as a counter electrode is formed on the second insulative substrate made of a glass or a plastic.

Further, an active matrix substrate and a counter substrate which are thus respectively processed to be a predetermined shape is bonded together by having a predetermined gap therebetween. Then, the gap is filled with a liquid crystal material to complete the display panel 2.

Next, a polarization film (not shown), such as a polarization plate, corresponding to the liquid crystal display mode is affixed to the display area of the display panel 2. Further, the display panel 2 is connected to a signal line driver (source driver 3) and a scanning line driver (gate driver 4) for driving the liquid crystal. Note that, in FIG. 5, the signal line driver and the scanning line driver are provided on the substrate of the display panel 2. Hereinafter, the signal line driver and the scanning line driver are respectively referred to as a source driver 3 and a gate driver 4.

In the present embodiment, the liquid crystal display device 1 has an arrangement such that the signal line 12 is formed to be 84 μm for the line width, 1500 Å for the thickness, and the liquid crystal layer has the thickness of 5 μm, and the liquid crystal material has permittivity anisotropy (ε⊥=5.5, ε//=7.9). Further, the liquid crystal display device 1 of which screen size is 15 inches has a XGA (extended graphics array) structure having 768 scanning lines and 3072 signal lines.

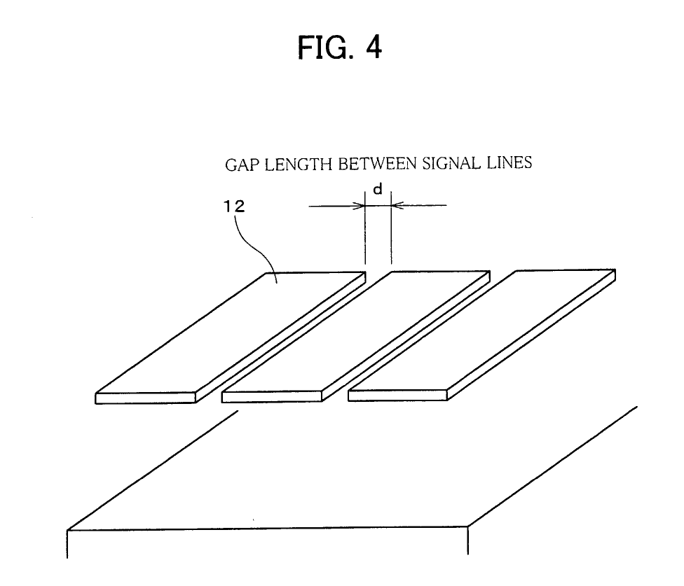

Here, since the signal line 12 also operates as a counter pixel electrode in the liquid crystal display device 1 having the counter signal line structure, it is necessary to set the width of the signal line 12 large enough for increasing an aperture ratio so as to realize a display device with desirable brightness and visibility. To meet this requirement, as shown in FIG. 4, the gap length d between the signal lines 12 becomes extremely small. Note that, the gap length d between the signal lines 12 is set to be 2 to 12 μm in the present embodiment.

Next, the following will explain a driving circuit (the source driver 3, the gate driver 4, the DC/DC converter 5, and the timing controller IC 6) of the liquid crystal display device 1 with reference to FIGS. 1 and 5.

As shown in FIG. 5, the DC/DC converter 5 converts an inputted power source into various power sources (a gate driver power source, a source driver power source, a gray scale power source, and a reference power source) used for driving the display panel 2.

Further, the timing controller IC 6 generates an image data signal, and a source driver timing signal and a gate driver timing signal for driving the source driver 3 and the gate driver 4 in accordance with the inputted signal. Further, the source driver timing signal includes a sampling start signal, a polarity signal, and an output start signal.

Here, four types of signals are included in an input signal inputted from such as a computer to the timing controller IC 6: a clock signal, a horizontal synchronization signal, a vertical synchronization signal and a data signal.

The clock signal and the data signal change at an extremely high speed while being synchronized with each other. The clock signal alternately repeats a voltage at high level and a voltage at low level at all times. The data signal changes its value depending on the display content of the pixels. However, the frame start time point and the line start time point in the scanning line direction cannot be judged by only using the clock signal and the data signal in the timing controller IC 6. Therefore, two synchronization signals, the horizontal synchronization signal and the vertical synchronization signal, are inputted to the timing controller IC 6.

In accordance with these four signals, the timing controller IC 6 counts the number of pulse of the horizontal synchronization signal after the point that vertical synchronization signal changes, and generates the polarity signal in accordance with the number of pulse. For example, the timing controller IC 6 generates the polarity signal specifying plus polarity for gray scale voltage when the number of pulse of the horizontal synchronization signal is an odd number, and generates the polarity signal specifying minus polarity for gray scale voltage when the number of pulse is an even number.

Further, the source driver timing signal, the data signal, and the source driver power source are inputted to the source driver 3 which drives the signal line 12. Further, the source driver 3 is supplied with power sources VsH and VsL respectively for plus polarity and minus polarity of the gray scale voltage corresponding to the data. Meanwhile, the gate driver timing signal and the gate driver power source are inputted to the gate driver 4 which drives the scanning line 11. Further, the reference voltage is directly inputted to the display panel 2 of the liquid crystal display device 1.

Next, with reference to FIG. 1, the following will explain a driving method of the signal line 12 in accordance with the gray scale power sources VsH and VsL, data signal, and the source driver timing signal (including the polarity signal) which are inputted to the source driver 3.

Firstly, a D/A converter 32 is capable of outputting two types of analog voltage value, i.e., a voltage for plus polarity and a voltage for minus polarity. A reference voltage of these two types of voltage is generated outside (DC/DC converter 5) of the source driver 3, and the gray scale power source VsH and the gray scale power source VsL are inputted to the source driver 3 respectively as a voltage for plus polarity and as a voltage for minus polarity. As thus described, in the source driver 3, two types of analog voltage outputted according to the data signal are previously prepared and ready to be outputted inside of the D/A converter 32.

Further, a line memory 31 included in the source driver 3 receives the sampling start signal so as to sequentially memory the data signal varying in synchronism with the clock signal.

Next, the D/A converter 32 prepares output of an analog gray scale voltage to an output pin of the source driver 3 so as to select a gray scale voltage corresponding to the sampled data. Here, the D/A converter 32 receives the polarity signal from the timing controller IC 6, and selects the polarity, plus or minus, of the output for each output pin according to the received polarity signal. For example, when the data signal outputs a voltage for displaying black, the gray scale power source VsH and the gray scale power source VsL are respectively adopted from a voltage of 10V and a voltage of 0V. Therefore, the voltage of the output pin can be two kinds: a voltage of 10V for plus polarity or a voltage of 0V for minus polarity.

Then, the D/A converter 32 selects either of the plus polarity voltage and the minus polarity voltage according to the inputted polarity signal, and outputs a corresponding analog voltage from each output pin. Namely, the D/A converter 32 uses the polarity signal for finally selecting and switching between the two gray scale voltages.

Therefore, for example, a switch proximate to the output pin of the source driver 3 may be provided with such an arrangement that when the polarity signal is high, a signal line Sm−1 becomes 0V, a signal line Sm becomes 10V, and a signal line Sm+1 becomes 10V, and when the polarity signal is low, the signal line Sm−1 becomes 10V, a signal line Sm becomes 0V, and a signal line Sm+1 becomes 0V. Note that, the signal lines Sm, Sm−1, and Sm+1 are output pins of the source driver 3.

Next, when the D/A converter 32 receives the output start signal from the timing controller IC 6, each output pin simultaneously outputs a gray scale voltage corresponding to the data signal.

The source driver 3 repeats the foregoing procedures for each scanning line 11 according to the control of the timing controller IC 6.

Next, the following will minutely explain a driving method of the liquid crystal display device 1 by a driving circuit with reference to FIGS. 1, 6, and 7. Note that, in the following explanation, an m-th signal line 12 will be described as a signal line Sm, and an n-th scanning line 11 will be described as a scanning line Gn.

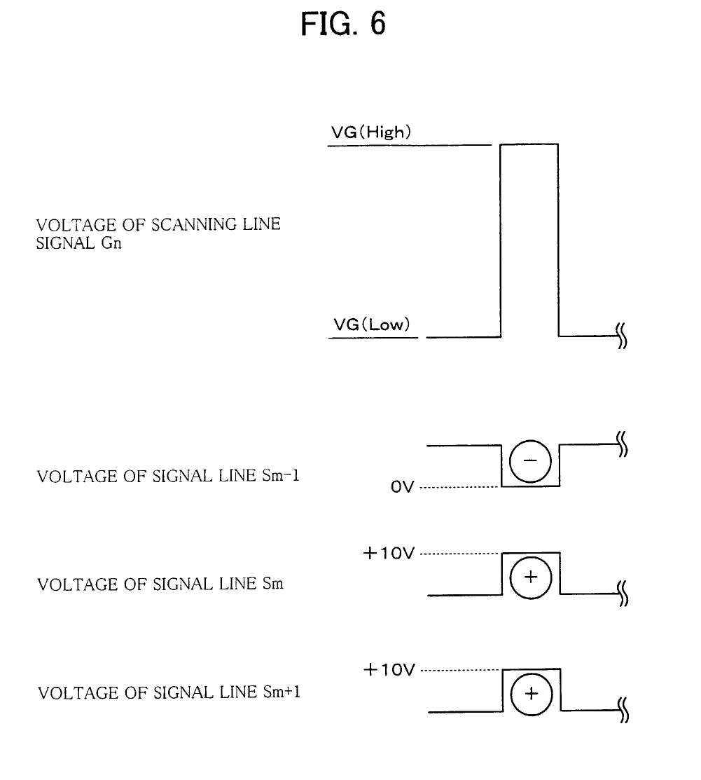

As shown in FIG. 6, in the liquid crystal display device 1, when the voltage of the n-th scanning line Gn is VG (High), all of the TFTs 14 connected to the scanning line Gn are turned on, and the voltage of the signal line 12 with respect to the voltage of the reference line 13 is charged to each pixel. With this operation, the liquid crystal is supplied with a desired voltage, thus realizing a display.

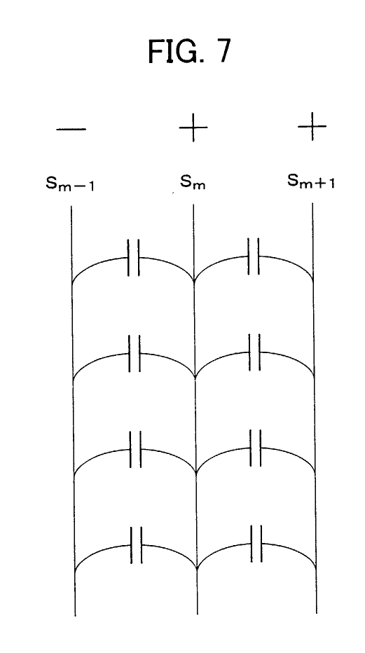

Here, as shown in FIG. 1, the source driver 3 determines the polarity of the output to each signal line 12 according to the polarity signal. For example, when the output to the mth signal line Sm is plus, the output to the m−1th signal line Sm−1 is minus, and the output to the m+1th signal line Sm+1 is plus. More specifically, as shown in FIG. 6, when each signal line is driven with a central voltage of +5V and an amplitude voltage of 10V, and if the signal line Sm is supplied with a plus polarity voltage (+10V), the signal line Sm−1, to the left of the signal line Sm, is supplied with a minus polarity voltage (0V), and the signal line Sm+1, to the right of the signal line Sm, is supplied with a plus polarity voltage (+10V) (FIG. 7).

Namely, looking at one specific signal line Sm of the plurality of signal lines 12, the source driver 3 carries out driving so that the signal lines Sm−1 and Sm+1, which are adjacent to the signal line Sm, are opposite in polarity to each other. More specifically, the source driver 3 drives signal lines that apply a voltage to a line of pixels scanned by a scanning line Gn so that the signal lines Sm−1 and Sm+1 at the both ends of three adjacent signal lines Sm−1, Sm and Sm+1 are respectively supplied with a voltage opposite to each other in polarity. As a result, a set of plus, plus, minus, minus in a signal line order is repeated for the polarity of the output voltage to the signal lines 12 in this driving method.

Here, as shown in FIG. 7, in this driving method, the signal line Sm is under the influence of the signal line Sm−1 disposed to the left of the signal line Sm since their voltages are opposite in polarity; however, the signal line Sm is not under the influence of the signal line Sm+1 provided to the right of the signal line Sm since their voltages are the same in polarity. Accordingly, the voltage variation of only one adjacent signal line affects on each signal line; that is, the influence of the voltage variation can be cut in half compared to the case of having the influence from both sides, i.e., a conventional driving method adopting the dot reversal drive scheme or the source line reversal drive scheme for the counter signal line structure.

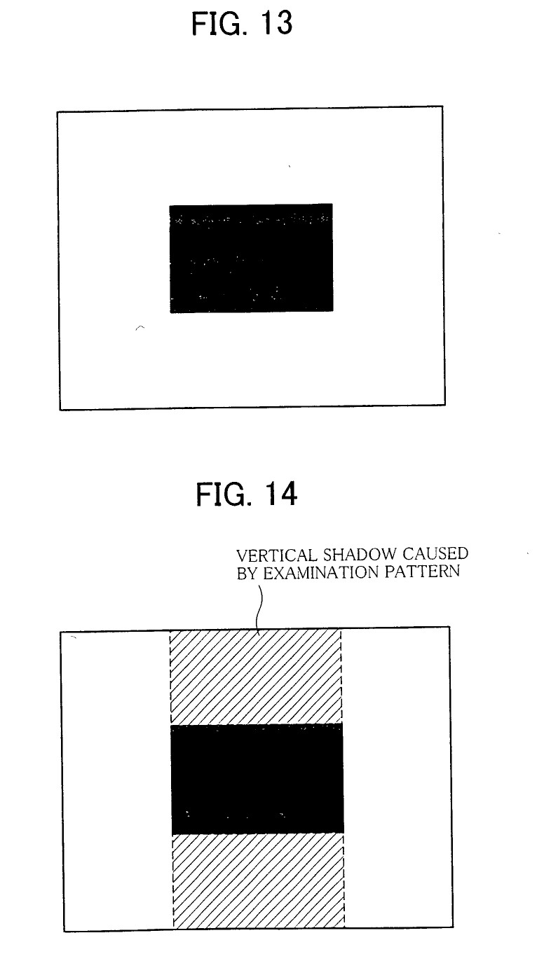

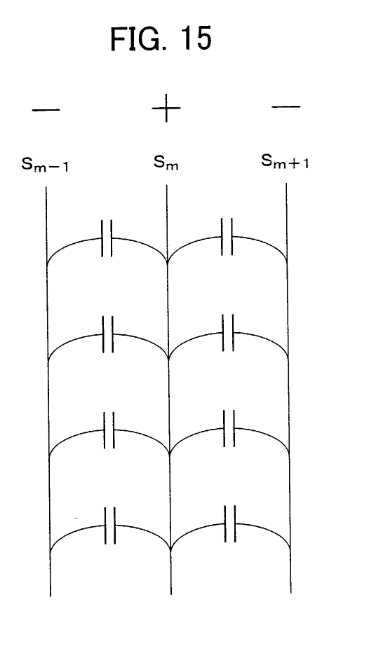

Consequently, for example, when the examination pattern shown in FIG. 13 is displayed in the display device, the vertical shadow of FIG. 14 becomes small, and the difference becomes invisible. Thus, the foregoing driving method makes it possible to prevent the voltage fluctuation caused by the adjacent signal lines even in the counter signal line structure having a short gap length between the signal lines and realizes a display without a shadow, thereby providing high display quality.

Next, the following will explain two concrete examples of the foregoing driving method.

(1) Two Horizontal Lines Source Reversal Drive Scheme

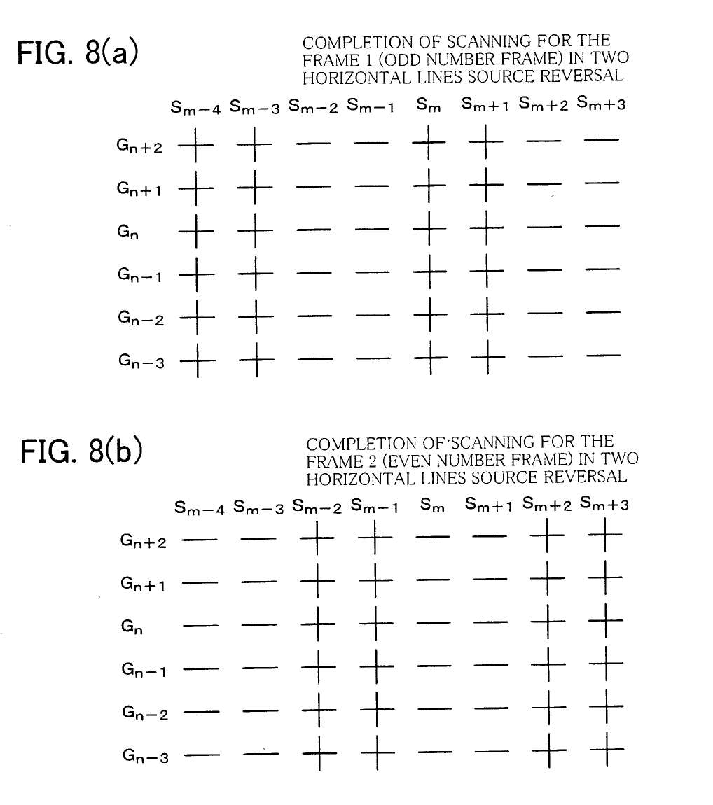

The following will explain a two horizontal lines source reversal drive scheme as the first example with reference to FIG. 8. FIG. 8(a) shows charge polarities of the pixel electrode 15 when scanning of an odd number frame has just completed. FIG. 8(b) shows charge polarities of the pixel electrode 15 when scanning of an even number frame has just completed.

In this example, as described, the driving is carried out so that signal lines Sm−1 and Sm+1, which are adjacent to a signal line Sm, are opposite in polarity to each other. For example, if the signal line Sm is supplied with a plus polarity voltage, the signal line Sm−1, to the left of the signal line Sm, is supplied with a minus polarity voltage, and the signal line Sm+1, to the right of the signal line Sm, is supplied with a plus polarity voltage. Accordingly, a set of plus, plus, minus, minus in a signal line order is repeated for the polarity of the signal lines 12.

Further, in this example, the driving is carried out in such a manner that the polarity of the signal line is not reversed for each scanning line 11 but is reversed when starting scanning of an even number frame after completing scanning of an odd number frame so that the odd number frame and the even number frame are respectively charged with a voltage opposite to each other in polarity. Namely, the source driver 3 reverses the polarity of the signal line for each frame.

In this manner, the voltage variation caused by the adjacent signal lines can be suppressed even in liquid crystal display device using the counter signal line structure having a short gap length between the signal lines and therefore realizes high display quality. Further, this driving method is performed in a manner similar to the conventional source line reversal drive scheme, and therefore a similar effect is expected. That is, since the polarity of the signal line 12 is reversed for each frame instead of for each 1H, the display consumes less power.

Further, in the foregoing driving method, an alternating electric field may be applied to the liquid crystal, as the charge polarity is alternately reversed for each frame. Thus, it is possible to greatly reduce probability that impurity ion in the liquid crystal is moved and attached to one side of the device, thereby improving reliability of the liquid crystal display device 1.

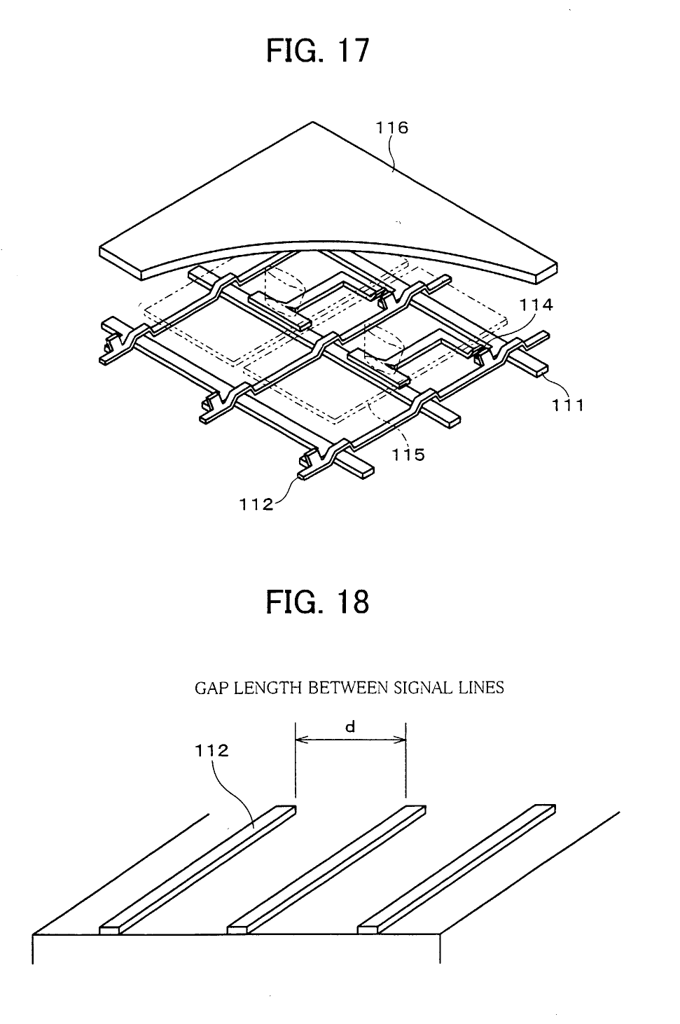

Here, FIG. 17 is an explanatory view showing an existing panel structure of the active matrix drive scheme.

In this existing panel structure, a scanning line 111, a signal line 112, a TFT 114, and a pixel electrode 115 (an auxiliary capacitive line of pixel in some cases) are disposed on a substrate (not shown), and a reference electrode 116, which is a common electrode for all pixels, is disposed on the other counter substrate (not shown), and these two substrates have liquid crystal filled in-between. Further, when this panel structure is realized by the XGA structure of which screen size is 15 inches having 768 scanning lines and 3072 signal lines, capacity at an intersection between the scanning line 111 and a signal line 112 is 16.9 fF per pixel.

For this reason, when a liquid crystal display device having the existing panel structure is driven by the driving method of the present example, the signal line 112 is likely to occur driving voltage delay, which causes inclination of the applied voltage in a signal line direction. This inclination is recognized as inclination of luminance and decreases display quality.

On the other hand, when the liquid crystal display device 1 having the counter signal line structure of FIG. 2 is realized by the foregoing configuration, the capacity at an intersection between the scanning line 11 and a signal line 12 is reduced to 5.2 fF per pixel, which is about ⅓ of the existing panel structure.

Accordingly, when the liquid crystal display device 1 is driven by the driving method of the present example, the signal line 12 is not likely to occur driving voltage delay and does not cause the inclination, thereby ensuring superior display quality.

(2) Two Horizontal Lines Dot Reversal Drive Scheme

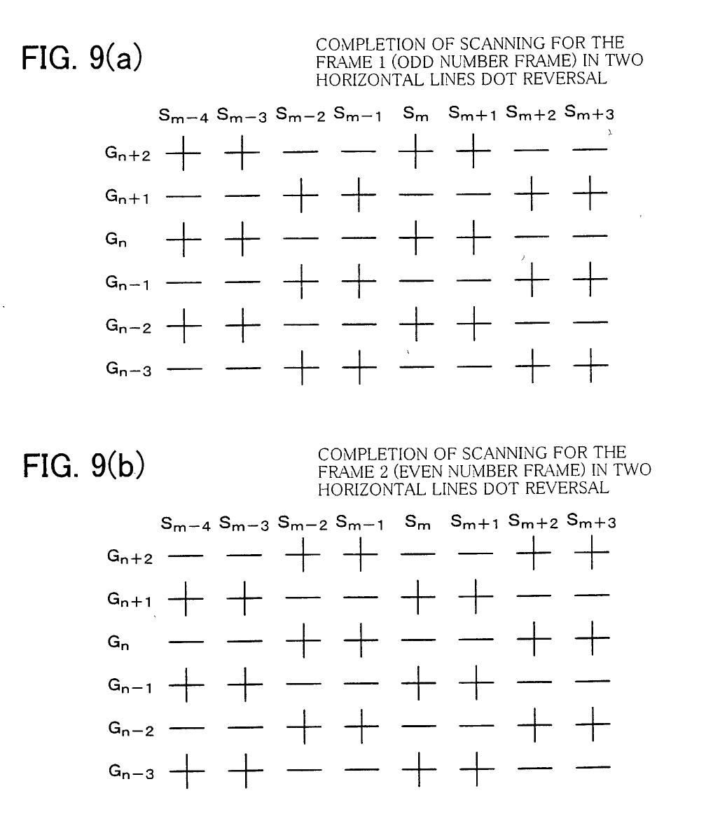

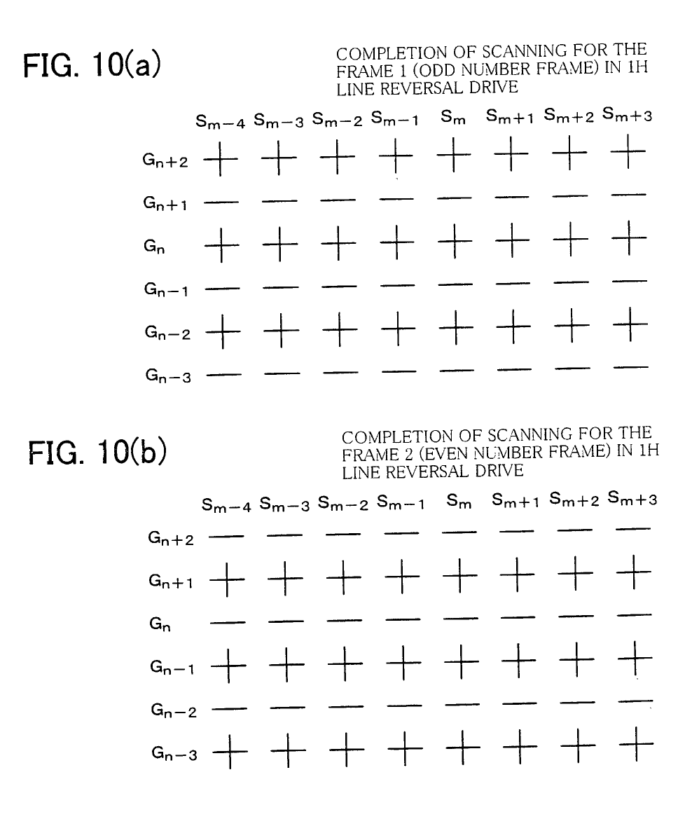

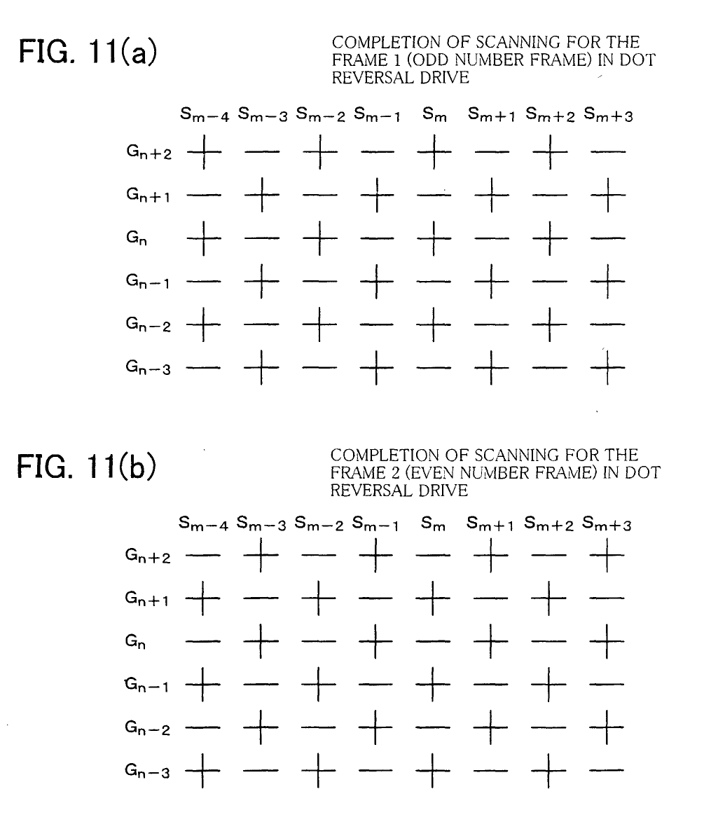

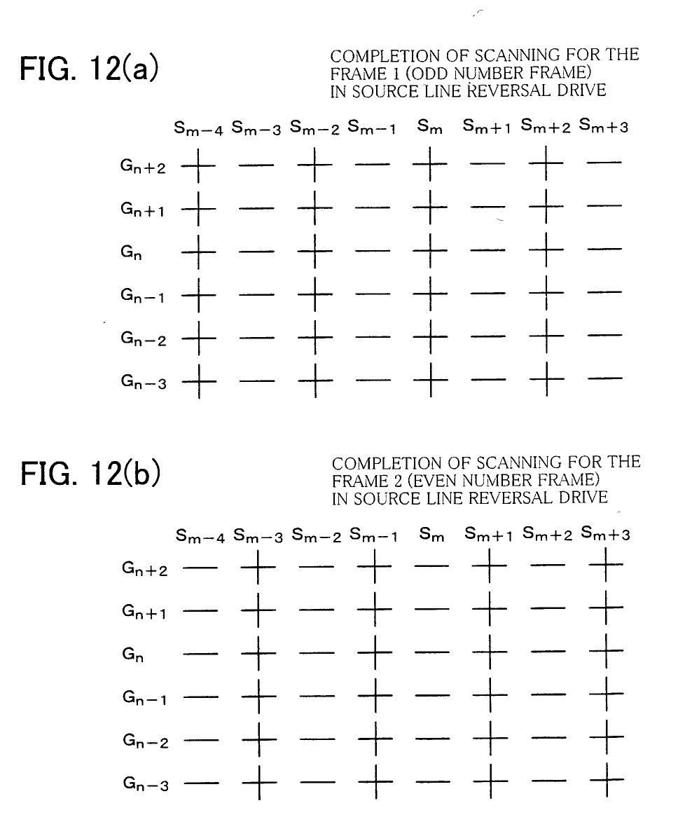

The following will explain a two horizontal lines dot reversal drive scheme as the second example with reference to FIG. 9. FIG. 9(a) shows charge polarities of the pixel electrode 15 when scanning of an odd number frame has just completed. FIG. 9(b) shows charge polarities of the pixel electrode 15 when scanning of an even number frame has just completed.

In this example, as described, the driving is carried out so that signal lines Sm−1 and Sm+1, which are adjacent to a signal line Sm, are opposite to each other in polarity. For example, if the signal line Sm is supplied with a plus polarity voltage, the signal line Sm−1, to the left of the signal line Sm, is supplied with a minus polarity voltage, and the signal line Sm+1, to the right of the signal line Sm, is supplied with a plus polarity voltage. Accordingly, a set of plus, plus, minus, minus in a signal line order is repeated for the polarity of the signal line 12.

Further, in this example, the driving is carried out in such a manner that the polarity of the signal line is reversed for each scanning line 11, and also is reversed when starting scanning of an even number frame after completing scanning of an odd number frame so that the odd number frame and the even number frame are charged with a voltage opposite to each other in polarity. Namely, the source driver 3 reverses the polarity of the signal line for each scanning line and for each frame.

In this manner, the influence of the voltage variation from the adjacent signal lines can be suppressed even in liquid crystal display device using the counter signal line structure having a short gap length between the signal lines, and therefore realizes high display quality. Further, this driving method is performed in a manner similar to the conventional dot reversal drive scheme, and therefore a similar effect is expected. That is, since a voltage opposite in polarity is written on vertically and horizontally adjacent sets of two pixels with respect to any given set of two pixels, the display causes less flicker.

Further, in the foregoing driving method, for the same reason as that of (1), an alternating electric field may be applied to the liquid crystal, as the charge polarity is alternately reversed for each frame. Thus, it is possible to greatly reduce probability that impurity ion in the liquid crystal is moved and attached to one side of the device, thereby improving reliability of the liquid crystal display device 1.

Further, in the foregoing driving method, for the same reason as that of (1), when the liquid crystal display device 1 is driven by the driving method of the present example, the signal line 112 is not likely to occur driving voltage delay and does not cause the inclination, thereby ensuring superior display quality.

Here, in the driving method of the present example, the polarity of the driving voltage of the signal line 12 is reversed for each scanning line, and this causes disturbance of electric field in an intersection between the scanning line 11 and the signal line 12. This disturbance of electric field occurs according to the size of capacity of the intersection. Further, this disturbance of electric field in the intersection also causes disturbance of electric field in the periphery of the pixel electrode 15 near the intersection, and makes it difficult to apply a desired voltage to the liquid crystal. However, the area where the disturbance of electric field occurs is subjected to light shielding by a black matrix.

In terms of this factor of the light shielding area against the disturbance of electric field, the existing panel structure shown in FIG. 17 and the liquid crystal display device 1 having the counter signal line structure shown in FIG. 2 are compared to each other, and the result has shown that the liquid crystal display device 1 is capable of light blocking by having a light blocking area of about ⅓ of that of the existing panel structure. Accordingly, when the driving method of the present example is adopted, the counter signal line structure can realize brighter and superior display quality than that of the existing panel structure.

Here, the following will additionally explain the background of the problems to be solved in the present invention.

As described, the liquid crystal display device 1 according to the present embodiment includes the display panel 2 of the active matrix drive scheme having the counter signal line structure shown in FIG. 2. On the other hand, the existing panel structure of the active matrix drive scheme has the arrangement shown in FIG. 5.

Further, as shown in FIGS. 4 and 18, a gap length between the signal lines greatly differs in the counter signal line structure and the existing panel structure. More specifically, a gap length d between the signal lines 12 of the counter signal line structure is extremely small, and it is set to be 2 to 12 μm in a liquid crystal display device with a general resolution. On the other hand, the gap length d between the signal lines 112 of the existing panel structure is set to be 40 to 90 μm.

The following will explain the reasons of the foregoing respective gap length d. In the counter signal line structure, since the signal line 12 also operates as a counter pixel electrode, it is necessary to set the width of the signal line 12 large enough for increasing an aperture ratio so as to realize display with desirable brightness and visibility. In contrast, in the existing panel structure, the signal line 112 only operates to input a signal voltage to the TFT 114, and it is desirable that the width of the signal line 112 is set as small as possible in terms of manufacturing so as to provide a large pixel electrode 15. Consequently, the gap length d between the signal lines becomes large.

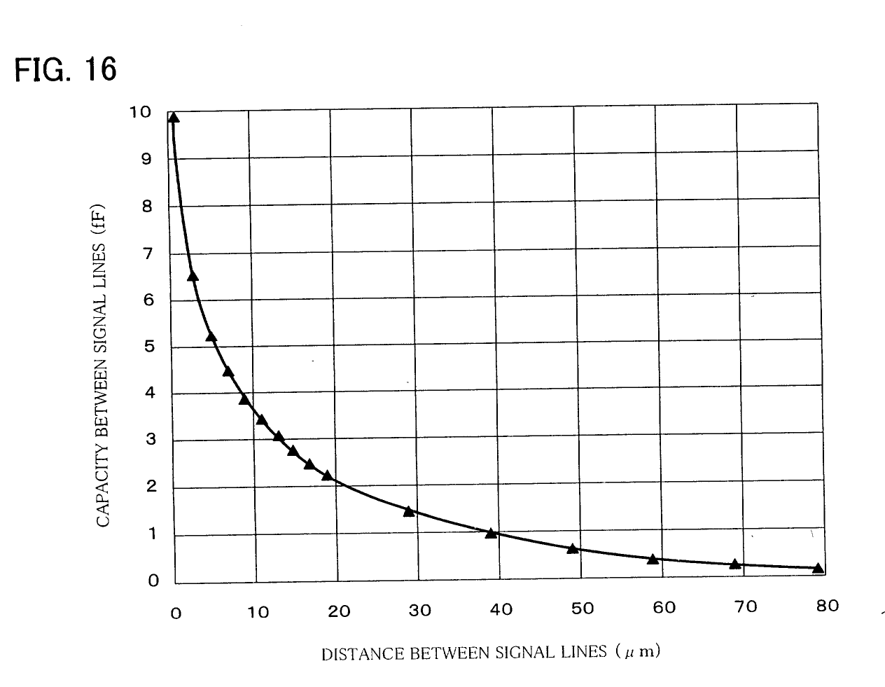

Next, FIG. 16 shows a result of a simulation for showing a relation between the variation of a capacity between the signal lines (parasitic capacity between the signal lines) and the variation of the gap length d between the signal lines (distance between the signal lines). The simulation was performed by using pixels having a certain size. As shown in FIG. 16, the capacity between the signal lines in the counter signal line structure shows a great value: about 20 times of the capacity between the signal lines in the existing panel structure. Note that, the capacity between the signal lines differs depending on the resolution of the display, and it has been revealed that a general display has variation of the capacity in a range of 10 times to 50 times.

The inventors of the present invention have discovered a particular problem of the display in the counter signal line structure due to this capacity between the signal lines, which is larger than that of the existing panel structure.

More specifically, the signal voltages of the adjacent signal lines affect on each other due to the large capacity therebetween, then, when an applied voltage of liquid crystal is held after the application, variation of the applied voltage between the adjacent signal lines varies the held voltage, and translucence quantity of liquid crystal changes. Note that, this problem is caused only in the dot reversal drive scheme and the source line reversal drive scheme. Further, in the existing panel structure, even though the variation of the applied voltage between the adjacent signal lines changes the translucence quantity of liquid crystal, it has not been considered as a problem in a conventional display device since the induced difference of display is small and invisible.

Note that, the inventors of the present invention had not found out the foregoing fact either before creation of an experimental production of the liquid crystal display device having the counter signal line structure and actual driving performance of the experimental production by the dot reversal drive scheme and the source line reversal drive scheme. Then, the performance of the experimental production led them to find out the particular problem in this structure. Further, various driving methods may be adopted for the existing panel structure in addition to the 1H line reversal drive scheme, the dot reversal drive scheme, and the source line reversal drive scheme.

Note that, the present invention is not limited to the present embodiment, and the same may be varied in many ways within the range thereof; for example, the following arrangements may also be adopted.

The liquid crystal display device according to the present invention that adopts the active matrix drive scheme with the counter signal line structure may be arranged such that signal lines, that apply a voltage to a line of pixels scanned by a scanning line, are driven so that the signal lines at the both ends of any three adjacent signal lines are respectively supplied with a voltage opposite to each other in polarity.

On this account, it is possible to greatly reduce a degradation of display quality caused by large capacity between signal lines, which has been a problem of a counter signal line structure panel when adopting the dot reversal drive scheme or the source line reversal drive scheme.

Further, the foregoing liquid crystal display device may be arranged such that the signal lines are supplied with a voltage that is reversed in polarity when starting scanning of a new frame after completing scanning of the previous frame.

Further, the foregoing liquid crystal display device may be arranged such that the signal lines are supplied with a voltage that is reversed in polarity for each scanning line and also when starting scanning of a new frame after completing scanning of the previous frame.

Further, the driving method of a liquid crystal display device according to the present invention is not limited to be used for the counter signal line structure, and may also be adopted for a liquid crystal display device having a short gap length between the signal lines.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A driving method of a liquid crystal display device,
the liquid crystal display device being arranged so that: an active three terminals element having a gate electrode, a drain electrode, and a source electrode is provided on a first substrate, the gate electrode being connected to a scanning line, the drain electrode being connected to a pixel electrode and the source electrode being connected to a reference line; and signal lines are provided on a second substrate opposite to the first substrate, the liquid crystal display device applying an electric field to a liquid crystal layer provided between the pixel electrode and the second substrate,
the method comprising the step of:
driving the signal lines that apply a voltage to a line of pixels scanned by the scanning line so that signal lines at both ends of any three adjacent signal lines are respectively supplied with a voltage opposite to each other in polarity.

2. The driving method of a liquid crystal display device as set forth in claim 1, wherein:
the signal lines are supplied with a voltage that is reversed in polarity for each frame.

3. The driving method of a liquid crystal display device as set forth in claim 1, wherein:
the signal lines are supplied with a voltage that is reversed in polarity for each scanning line.

4. The driving method of a liquid crystal display device as set forth in claim 2, wherein:
the signal lines are supplied with a voltage that is reversed in polarity for each scanning line.

5. A liquid crystal display device, comprising:
a first substrate including a scanning line, a reference line, a pixel electrode, and an active three terminals element having a gate electrode connected to the scanning line, a source electrode connected to the reference line, and a drain electrode connected to the pixel electrode;
a second substrate including signal lines provided on a side opposite to the first substrate;
a liquid crystal layer held between the pixel electrode and the second substrate; and
a driving circuit for driving the signal lines that apply a voltage to a line of pixels scanned by the scanning line so that signal lines at both ends of any three adjacent signal lines are respectively supplied with a voltage opposite to each other in polarity.

6. The liquid crystal display device as set forth in claim 5, wherein:
the driving circuit supplies a voltage to the signal lines by reversing the voltage in polarity for each frame.

7. The liquid crystal display device as set forth in claim 5, wherein:
the driving circuit supplies a voltage to the signal lines by reversing the voltage in polarity for each scanning line.

8. The liquid crystal display device as set forth in claim 6, wherein:
the driving circuit supplies a voltage to the signal lines by reversing the voltage in polarity for each scanning line.
